(19) United States
(12) Patent Application Publication
(10) Pub. No.: US 2014/0253080 A1
(43) Pub. Date: Sep. 11, 2014

(54) METHOD AND APPARATUS FOR ADVANCED PULSE SKIPPING CONTROL IN BUCK REGULATORS

(71) Applicant: QUALCOMM INCORPORATED, San Diego, CA (US)

(72) Inventors: Xufeng Jiang, San Diego, CA (US); Chunlei Shi, San Diego, CA (US); Sugato Mukherjee, San Diego, CA (US)

(73) Assignee: QUALCOMM INCORPORATED, San Diego, CA (US)

(21) Appl. No.: 13/793,703

(22) Filed: Mar. 11, 2013

(51) Int. Cl. G05F 1/62

(52) U.S. Cl. CPC G05F 1/62
USPC 323/284

(57) ABSTRACT

A method and apparatus for determining the entry and exit from a pulse skipping mode in a power supply is provided. The power supply may incorporate a buck regulator. The method begins when current is sensed at an inductor of a power supply. This sensed current is then compared with a predetermined threshold current value. If the comparison reveals that the current is below the predetermined threshold current value, a pulse skipping mode is entered. If the current is found to be above the predetermined threshold the pulse skipping mode is not entered and normal operation continues. The apparatus includes a transconductance amplifier, an offset voltage source, a reference power supply reference voltage source, first and second voltage comparators, and a processor.

### BACKGROUND

1. Field

The present disclosure relates generally to communication systems, and more particularly to a method and apparatus for providing control of the threshold for entering pulse skipping mode and for determining the threshold for exiting pulse skipping mode.

2. Background

A pulse-width modulation (PWM) switching regulator requires a pulse skipping mode in order to avoid constantly turning on and off the power field effect transistors (FETs) when operating in light load conditions. This skipping mode saves power and as a result also saves battery power. Saving battery power is becoming increasingly important in mobile devices such as cell phones. Increasingly, mobile devices are used to run a wide variety of applications and perform additional tasks, all of which may heavily drain the device battery. Determining when to enter and when to exit the pulse skipping mode effects operating efficiency of the device and may also affect the quality of the output of the PWM switching regulator.

Current solutions for pulse skipping have variable thresholds for entering the pulse skipping mode. The decision to enter or exit pulse skipping mode may depend on operating conditions, including input and/or output voltage, inductance, switching frequency, and other factors. These current methods suffer from the disadvantage that control of entry and exit of the pulse skipping mode is not independent. The threshold of entering or exiting pulse skipping may not be under control. In addition, the pulse skipping ripple voltage may not be under control.

There is a need in the art for a method and apparatus providing an advanced pulse skipping scheme that allows for directly sensing the inductor current by a lossless observer, thus providing control of the entry threshold for pulse skipping. In addition, there is a need in the art for a method and apparatus for determining the exit threshold for exiting pulse skipping, which in turn provides control of the pulse skipping ripple voltage.

### SUMMARY

Embodiments disclosed herein provide a method an apparatus for determining the entry and exit from a pulse skipping mode in a power supply. The method begins when current is sensed at an inductor of a power supply. This sensed current is then compared with a predetermined threshold current value. If the comparison reveals that the current is below the predetermined threshold current value, a pulse skipping mode is entered. If the current is found to be above the predetermined threshold the pulse skipping mode is not entered and normal operation continues.

A further embodiment provides an apparatus for determining entry to and exit from a pulse skipping mode in a power supply. The apparatus includes a transconductance amplifier, an offset voltage source, a reference power supply reference voltage source, first and second voltage comparators; and a processor.

A still further embodiment provides an apparatus for determining the entry to and exit from a pulse skipping mode in a power supply. The apparatus includes means for sensing a current at an inductor of a regulator; means for comparing the sensed current with a predetermined threshold current value; means for determining if the sensed current is below the predetermined threshold current value; and means for entering a pulse skipping mode if the sensed current is below the predetermined threshold level.

Yet a further embodiment provides a non-transitory computer-readable medium, which when executed by a processor causes the processor to perform the following steps: sense a current at an inductor of a regulator and then compare that sensed current with a predetermined voltage value. The non-transitory computer-readable medium then determines if the sensed current is below the predetermined threshold current value. The non-transitory computer-readable medium then directs entry to the pulse skipping mode.

### BRIEF DESCRIPTION OF THE DRAWINGS

FIG. 1 illustrates control of entry to and exit from pulse skipping mode, according to an embodiment.

FIG. 2 illustrates a block diagram for pulse code modulation with pulse skipping according to an embodiment.

FIG. 3 depicts the voltages measured and entry and exit control provided by an embodiment.

FIG. 4 is a flow diagram of a method for determining entry and exit from a pulse skipping mode in a power supply, according to an embodiment.

### DETAILED DESCRIPTION

Various aspects are now described with reference to the drawings. In the following description, for purposes of explanation, numerous specific details are set forth in order to provide a thorough understanding of one or more aspects. It may be evident, however, that such aspect(s) may be practiced without these specific details.

As used in this application, the terms “component,” “module,” “system” and the like are intended to include a computer-related entity, such as, but not limited to hardware, firmware, a combination of hardware and software, or software in execution. For example, a component may be, but is not limited to being, a process running on a processor, a processor, an object, an executable, a thread of execution, a program and/or a computer. By way of illustration, both an application running on a computing device and the computing device can be a component. One or more components can reside within a process and/or thread of execution and a component may be localized on one computer and/or distributed between two or more computers. In addition, these components can execute from various computer readable media having various data structures stored thereon. The components may communicate by way of local and/or remote processes such as in accordance with a signal having one or more data packets, such as data from one component interacting with another component in a local system, distributed system, and/or across a network such as the Internet with other systems by way of the signal.

Moreover, the term “or” is intended to mean an inclusive “or” rather than an exclusive “or.” That is, unless specified otherwise, or clear from the context, the phrase “X employs A or B” is intended to mean any of the natural inclusive permutations. That is, the phrase “X employs A or B” is satisfied by any of the following instances: X employs A; X employs B; or X employs both A and B. In addition, the articles “a” and “an” as used in this application and the appended claims should generally be construed to mean “one or more” unless specified otherwise or clear from the context to be directed to a singular form.

The present innovation is directed to a method and apparatus for advanced skipping control in a buck regulator. The method provides for independent control of the entry and exit of the pulse skipping mode. The decision of entry may be made in light load conditions. This avoids the problem in peak current mode (PCM) control of voltage error (V_{ERR}) and load mismatch. The decision of exit may occur when the output voltage ripple becomes too large, which indicates an output voltage (V_{OUT}) dip or decrease.

A buck converter or regulator, is a step-down DC to DC converter. In design it may be similar to a step-up boost converter. A buck regulator is a switched-mode power supply that uses two switches, typically a transistor and a diode, as well as an inductor and a capacitor.

In operation, the simplest way to reduce the voltage of a DC power supply is to use a linear regulator. However, linear regulators waste energy as they operate. This wasted energy is dissipated as heat, which may be undesirable in a portable or mobile device such as a wireless phone or laptop computer. Excess heat may also cause shorter battery life and adversely affect device operation.

Buck regulators, in contrast, may be quite efficient, 95% or higher for integrated circuits and may be used to convert the main voltage in a computer or other device down to the lesser voltage needed by the processor. Typical voltages reduced range from 12-24 volts for a desktop or laptop computer, while typical processor voltages range from 0.8-1.8 volts.

Buck regulator operation is somewhat simple. The device, as described above, consists of an inductor and two switches, which are usually a transistor and a diode that control the inductor. The buck regulator alternates between connecting the inductor to a voltage source to store energy in the inductor and discharging the inductor into the load.

Conceptually, the buck regulator operates on the basis of an inductor's “reluctance” to allow a change in current. Starting with the switch in the open or “off” position, the current in the circuit is zero. When the switch is first closed, the current begins to increase, however, the inductor attempts to fight the increase by dropping the voltage. This voltage drop counteracts the voltage of the source and as a result reduces the net voltage across the load. Over time, the inductor allows the current to slowly increase by decreasing the voltage being dropped and therefore increasing the net voltage seen by the load. During this time, the inductor is storing energy in the form of a magnetic field.

If the switch is opened before the inductor has fully charged, that is before it has allowed all of the current to pass through by reducing its own voltage drop to zero, then there will always be a voltage drop across the inductor. As a result, the net voltage seen by the load will be less than the input voltage source.

When the switch is opened again, the voltage source is removed from the circuit, so the current will attempt to drop. Once again, the inductor fights against this change in current, and does so by reversing the voltage direction and acting like a voltage source. In other words, there is a certain current flowing through the load due to the input voltage source. In order to maintain this current when the input voltage source is removed, the inductor takes the place of the voltage source and provides the same net voltage to the load. Over time, the inductor may allow the current to gradually decrease, which is done by decreasing the voltage across the inductor. During this time, the inductor discharges its stored energy, drawn from its collapsing magnetic field, into the rest of the circuit.

If the switch is closed again before the inductor fully discharges, the load continually sees a non-zero voltage. The capacitor that is placed in parallel with the load assists in smoothing out the voltage waveform as the inductor charges and discharges in each cycle.

A buck regulator may operate in continuous mode if the current through the inductor does not fall to zero during the commutation cycle. When the switch is closed the current through the inductor rises linearly. As the diode is reverse biased by the voltage source, no current flows through the diode. When the switch is opened the diode is forward biased. The current then decreases. Therefore, the energy stored in the inductor increases during on-time as the current increases and then decreases during the off state. The inductor thus transfers energy from the input to the output of the converter. If the buck regulator operates in steady state, the energy stored in each component at the end of a commutation cycle is equal to that at the beginning of the cycle. Thus the current is the same at the beginning and end of the cycle. This type of operation may be known as steady state.

In some cases, the amount of energy required by the load is small enough to be transferred in a time less than the entire commutation period. When this occurs, the current in the inductor falls to zero during part of the commutation period. In this type of discontinuous mode operation, the inductor is fully discharged at the end of the commutation cycle. The output current delivered to the load is constant, if the output capacitor is large enough to maintain a constant voltage across its terminals during a commutation cycle. This implies that the current flowing through the capacitor has a zero average value. The converter operates in discontinuous mode when the load draws low current and in continuous mode when the current draw is higher.

A pulse width modulated (PWM) switching regulator needs to enter pulse skipping mode to avoid constantly turning on and off the power field effect transistors (FETs) when operating under light load. This is done to save power. However, it can be relatively difficult to control the entry threshold, which determines when the buck regulator enters the pulse skipping mode, particularly under the conditions of wide input and output voltages and switching frequency. If the threshold is too low, the regulator may enter PWM at light loads, resulting in unnecessary switching losses. On the other hand, if the threshold is too high, the buck regulator may skip pulses when in the normal PWM mode, which may cause larger ripple or sub-harmonics at the output of the regulator.

Prior methods of determining the thresholds for entry of pulse skipping mode have relied on creating an imbalance between the inductor current and the load current. This has been done by using a minimum PFET on (PON) time. However, these thresholds may be very difficult to set, especially under different duty cycles and load conditions.

Another prior method directly senses the output voltage error and compares that error with a threshold. This requires timing hysteresis to avoid mode oscillation as well as transient interference. In this approach, the threshold may be indirectly related to load current.

The method described herein provides an independent advanced pulse skipping scheme that allows independent control of entry and exit of the pulse skipping mode. In this method, inductor current is directly sensed by a lossless observer. In addition, the pulse skipping ripple voltage is under control as the exit threshold for pulse skipping is determined by a dropping output.

The innovation uses two threshold voltages and two sets of comparators. The load condition controlling the load condition for entry into pulse skipping mode is the pulse skipping voltage reference set, Vps_ref_SET. Vps_ref_SET is the threshold for entering pulse skipping. Ripple during pulse skipping is controlled by the pulse skipping voltage reference reset, Vps_ref_RESET. Timing hysteresis may be needed in order to bypass the load transient dynamics.

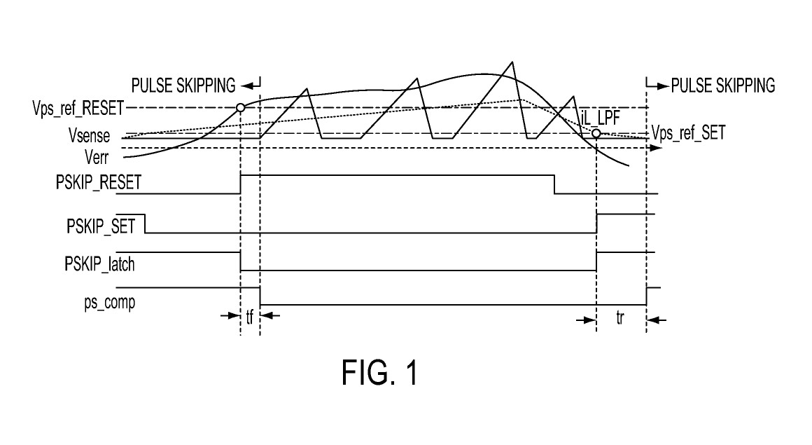

FIG. 1 illustrates the control described above and also indicates the relationship between the voltages. The highest voltage is Vps_ref_RESET, which controls ripple during pulse skipping, and serves as a second voltage threshold. FIG. 1 also depicts how the voltage representing the sensed inductor current, Vsense, and the amplified voltage error, Verr are related to Vps_ref_RESET, and how they vary as the waveform varies. Vps_ref_SET controls the load condition for entry into pulse skipping mode and serves as a first voltage threshold for entering pulse skipping. The sensed inductor current passing through the low pass filter, iL LPF is also shown. Pulse skipping reset, PSKIP_RESET and pulse skipping set, PSKIP_SET are below the Vsense and Verr values. PSKIP_SET is the output of a first voltage comparator, which compares the voltage of iL_LPF with Vps_ref_SET, and it goes high only if iL_LPF is less than Vps_ref_SET. PSKIP_RESET is the output of a second voltage comparator, which compares the voltage of Verr with Vps_ref_RESET, and it goes high only if Verr is larger than Vps_ref_RESET. Pulse skipping latch curves, PSKIP_latch, are below PSKIP_SET curves. PSKIP_latch is generated by digital logic gates from PSKIP_SET and PSKIP_RESET signals. It may be used directly for pulse skipping mode control. Timing hysteresis is shown in FIG. 1 as delay in signal PSKIP_latch rising edge and/or delay tf in PSKIP_latch falling edge. Use of timing hysteresis is optional, and may be used in the event of a mis-triggering of pulse skipping mode.

In operation, the pulse skipping mode entry and exit is controlled independently. Pulse skipping mode may be entered in light load conditions, so as to avoid the problems in peak current mode control, voltage error and load mismatch. Exit from the pulse skipping mode may occur when the ripple becomes too large, which is the indicator of a decrease or a dip at the output voltage, Vout.

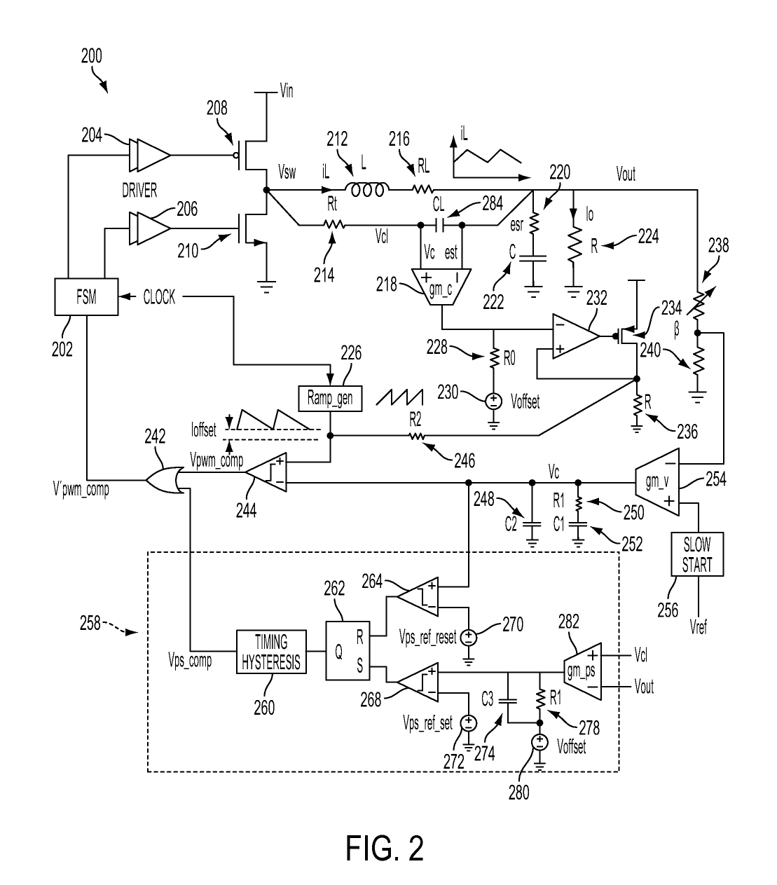

FIG. 2 illustrates an assembly 200 incorporating a pulse skipping module 258. In addition, FIG. 2 illustrates the control diagram for peak current mode controller with pulse skipping feature. FSM 202 provides inputs to drivers 204 and 206. Driver 204 provides input to transistor 208, which also receives a voltage input, V_{IN}. Transistor 210 is connected to ground and to transistor 208. The output from transistors 208 and 210, V_{SW} is provided to inductor 212. At this point in the circuit, current i_{L} is provided to inductor 212. An additional output from transistors 208 and 210 is provided to resistor 214, Rₜ. The resistor 216, R_{L} represents the winding DC resistance of the inductor 212 plus the possible printed circuit board (PCB) resistance. The voltage after Rₜ 214 is V_{CL} and is provided to the positive terminal of transconductance amplifier 218 as V_{C}. A capacitor C_{L} 284 is connected between the positive and negative inputs to transconductance amplifier 218. The negative terminal of transconductance amplifier 218 is tied to the output from R_{L} 216 and the combined output is regulator output voltage Vout. The output capacitor of the regulator is illustrated as a bulk capacitor 222 in series with the parasitic esr resistance, Resr, and then grounded. Resistor 224 illustrates the regulator load as pure resistance. Output voltage V_{OUT} is provided to variable resistor 238, which is connected to resistor 240 and thence to ground, for the purpose of programmable output voltage. The output of variable resistor 238 is also provided to transconductance amplifier 254 on the negative input. The positive terminal of transconductance amplifier 254 is connected to slow start module 256, which accepts a reference voltage V_{ref} as input.

Transconductance amplifier 218 is connected to resistor R_{O} 228. Resistor 228 is connected to offset voltage source 230, which is also connected to ground. Transconductance amplifier 218 is also connected to the negative terminal of amplifier 232. Amplifier 232 provides input to transistor 234. Transistor 234 is also connected to resistor 236. Transistor 234 is also connected to ramp generator 226 through resistor R₂ 246 and from there to comparator 244 on the positive terminal Ramp generator 226 accepts clock as input, while the same clock is also provided to FSM 202. At this point the sensed inductor current with an offset current I_{offset} is combined with the current generated by 226, ramp generator and converted to a voltage signal for voltage comparator 244.

Transconductance amplifier 254 is connected to resistor R₁ 250. Resistor 250 is connected to capacitor C₁ 252, and from there to ground. The output of transconductance amplifier 254 is connected in parallel with capacitor C₂ 248. The output is also provided to voltage comparator 244 on the negative terminal

The output is also provided to the pulse skipping module 258, specifically to voltage comparator 264 on the positive input. The negative input of voltage comparator 264 is connected to a power supply voltage reference reset, Vps_REF_RESET 270. The output from voltage comparator 264 is provided to the R input of digital R-S latch module 262. The S input to digital R-S latch module 262 is provided by voltage comparator 268, which has Vps_REF_SET voltage source 272 as one of its inputs.

Transconductance amplifier 282 receives the voltages across capacitor CL, 284 as inputs, with V_{cl} on the positive terminal and Vₒᵤₜ on the negative terminal. The output of transconductance amplifier 282 is provided to the parallel resistor 278 and capacitor 274. The shunted resistor 278 and capacitor 274 are also connected to offset voltage source 280. Voltage source 280 and 230 should have identical output as Voffset.

The digital R-S latch module 262 output is provided to the timing hysteresis module 260. This module may be used in the event there is a mis-triggering and pulse skipping mode is entered at an incorrect or undesired voltage. Timing hysteresis module 260 provides Vps_comp to OR gate 242. OR gate 242 also receives input from comparator 244. OR gate 242 provides input to FSM module 202 and this information is used to trigger pulse skipping mode.

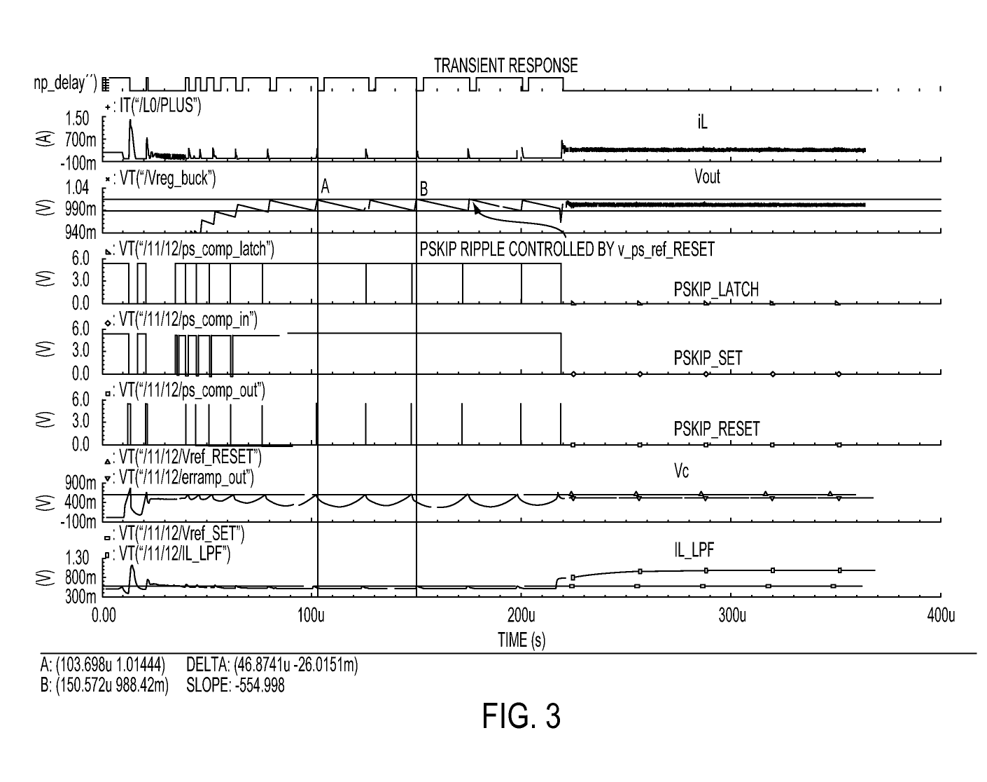

FIG. 3 shows the voltages measured using the embodiment shown in FIG. 2 and described above. In FIG. 3, entry to pulse skipping may be observed in the graph for IL_LPF. This is one of the inputs to the second comparator, the other input is Vref_SET. V_{C} is the one of the inputs from the first comparator, and the other input is Vref_RESET. PSKIP_RESET is the output from the second comparator and PSKIP_SET is the output from the first comparator. In operation, ripple in PSKIP is controlled by V_PS_REF_RESET. The output voltage curve Vₒᵤₜ then shows the exit from pulse skipping. IL shows the inductor current. FIG. 3 illustrates the entry and exit control provided by the embodiments described herein.

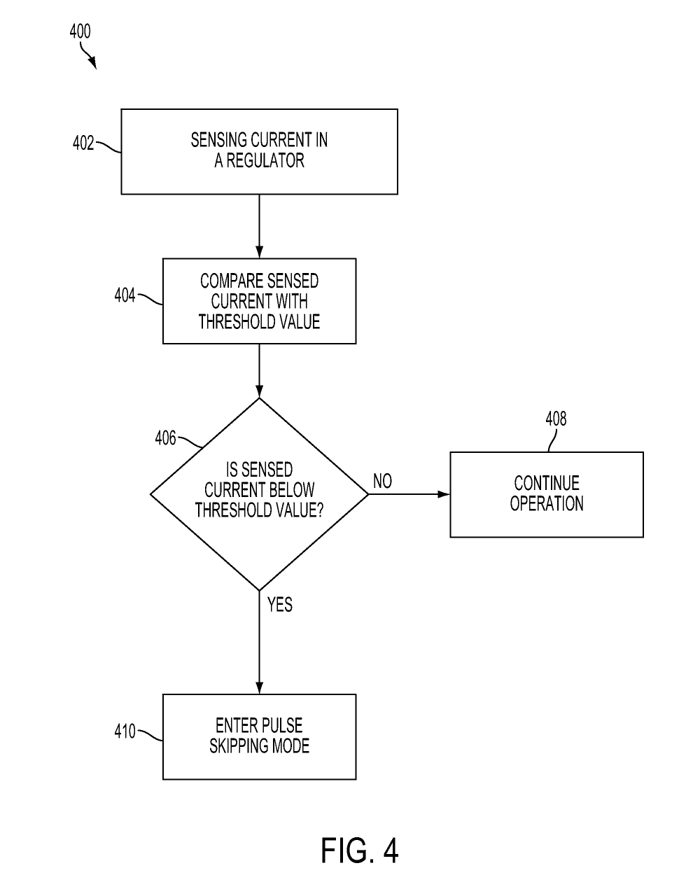

FIG. 4 is a flowchart of a method 400 of providing advanced pulse skipping control in a buck regulator. The method 400 begins when current in a regulator is sensed at step 402. This sensed current is then compared with a threshold value in step 404. In decision block 406 the test is whether the current sensed is below a threshold value. If the value is not below the threshold value, then in step 408 operation is continued and the pulse skipping mode is not entered. This may occur because the sensed current is at a higher value, indicating active operations requiring additional current. If the sensed current is below the threshold value, pulse skipping mode is entered in step 410.

Threshold values may be determined based on the type of operation the accompanying circuit is performing. The pulse skipping mode may be suitable for a wide variety of variable load situations. While the embodiment is shown in use with a circuit for peak current mode controller such as would be used in a communication device, the innovation may be used with any buck regulator.

In operation the embodiments described here provide a method for determining entry and exit from a pulse skipping mode in a power supply. The method begins with sensing a current at an inductor of a regulator. The regulator may be a buck regulator, however, any suitable power supply regulator may be used. The sensed current at the inductor is then compared with a predetermined threshold current value. If the current value is below the predetermined threshold value, pulse skipping mode is entered. If the current value is above the predetermined threshold, operation continues as before, and the pulse skipping mode is not entered.

The method described above may also include measuring a voltage at the output of a voltage regulator, such as a buck regulator. If a voltage drop is detected at the output of the regulator the pulse skipping mode may be exited if the detected voltage after the voltage drop is lower than the predetermined voltage threshold. The voltage threshold may be varied depending on the usage scenario and may also be based upon device usage. In addition, the threshold may be varied based on the requirements of an application program or based upon load requirements.

It is understood that the specific order or hierarchy of steps in the processes disclosed is an illustration of exemplary approaches. Based upon design preferences, it is understood that the specific order or hierarchy of steps in the processes may be rearranged. The accompanying method claims present elements of the various steps in a sample order, and are not meant to be limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language claims, wherein reference to an element in the singular is not intended to mean “one and only one” unless specifically so stated, but rather “one or more.” Unless specifically stated otherwise, the term “some” refers to one or more. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed as a means plus function unless the element is expressly recited using the phrase “means for.”

What is claimed is:

1. A method for determining entry and exit from a pulse skipping mode in a power supply, comprising:
sensing a current at an inductor of a regulator;
comparing the sensed current with a predetermined threshold value;
determining if the sensed current is below the predetermined threshold current value; and
entering the pulse skipping mode if the sensed current is below the predetermined threshold current value.

2. The method of claim 1, further comprising:
measuring a voltage at an output of a regulator;
detecting a voltage drop at the output of the regulator; and
exiting the pulse skipping mode if the detected voltage is lower than a predetermined voltage threshold.

3. The method of claim 1, wherein the threshold may be varied.

4. The method of claim 3, wherein the threshold is varied based on device usage.

5. The method of claim 3, wherein the threshold is varied based on an application program requirement.

6. The method of claim 3, wherein the threshold is varied based on the load requirement.

7. An apparatus for determining entry and exit from a pulse skipping mode in a power supply, comprising:
a transconductance amplifier;
an offset voltage source;
a power supply reference voltage source;
first and second voltage comparators; and
a processor.

8. The apparatus of claim 7 further comprising a timing hysteresis module.

9. The apparatus of claim 8 wherein the timing hysteresis module contains a second processor.

10. An apparatus for determining entry and exit from a pulse skipping mode in a power supply, comprising:
means for sensing a current at an inductor of a regulator;
means for comparing the sensed current with a predetermined threshold value;
means for determining if the sensed current is below the predetermined threshold current value; and
means for entering the pulse skipping mode if the sensed current is below the predetermined threshold current value.

11. The apparatus of claim 10, further comprising:
means for measuring a voltage at an output of a regulator;
means for detecting a voltage drop at the output of the regulator; and
means for exiting the pulse skipping mode if the detected voltage is lower than a predetermined threshold.

12. The apparatus of claim 10, further comprising means for varying the threshold.

13. The apparatus of claim 12, wherein the means for varying the threshold varies the threshold based on device usage.

14. The apparatus of claim 12, wherein the means for varying the threshold varies the threshold based on an application program requirement.

15. The apparatus of claim 12, wherein the means for varying the threshold varies the threshold based on the load requirement.

16. A non-transitory computer-readable medium containing instructions, which when executed by a processor, cause the processor to perform the following steps:
sensing a current at an inductor of a regulator;
comparing the sensed current with a predetermined threshold value;
determining if the sensed current is below the predetermined threshold current value; and
entering the pulse skipping mode if the sensed current is below the predetermined threshold current value.

17. The non-transitory computer-readable medium of claim 16, further containing instructions for performing the following steps:
measuring a voltage at an output of a regulator;
detecting a voltage drop at the output of the regulator; and
exiting the pulse skipping mode if the detected voltage is lower than a predetermined voltage threshold.

18. The non-transitory computer-readable medium of claim 16, wherein the instructions cause the processor to vary the threshold.

19. The non-transitory computer-readable medium of claim 18, wherein the instructions cause the processor to vary the threshold based on device usage.

20. The non-transitory computer-readable medium of claim 18, wherein the instructions cause the processor to vary the threshold based on an application program requirement.

21. The non-transitory computer-readable medium of claim 18, wherein the instructions cause the processor to vary the threshold based on a load requirement.
